(19) United States
(12) Patent Application Publication
(10) Pub. No.: US 2014/0027360 A1
(43) Pub. Date: Jan. 30, 2014

(54) FILTRATION APPARATUS AND HOLLOW FIBER MEMBRANE MODULE THEREFOR

(71) Applicant: Kwang-Jin Lee, Yongin-si (KR)

(72) Inventor: Kwang-Jin Lee, Yongin-si (KR)

(73) Assignee: KOLON INDUSTRIES, INC., Gwacheon-si, Gyeonggi-do (KR)

(21) Appl. No.: 14/004,769

(22) PCT Filed: Mar. 16, 2012
(86) PCT No.: PCT/KR12/01912

§ 371 Date: Oct. 4, 2013

(30) Foreign Application Priority Data
Mar. 16, 2011 (KR) 10-2011-0023205
Mar. 31, 2011 (KR) 10-2011-0029613
Apr. 1, 2011 (KR) 10-2011-0030017

(51) Int. Cl. B01D 63/02

(52) U.S. Cl. CPC B01D 63/02
USPC 210/99; 210/321.87

(57) ABSTRACT

Disclosed are a filtration apparatus having the advantages of conventional pressurized-type and submerged-type filtration apparatuses and a hollow fiber membrane module therefor. The filtration apparatus of the present invention comprises: a tank into which feed water is to be introduced, the tank comprising first and second inner step surfaces arranged opposite to each other; and a hollow fiber membrane module to be submerged in the feed water introduced in the tank, the hollow fiber membrane module comprising first and second headers and a hollow fiber membrane therebetween, wherein first and second ends of the first header are supported by the first and second inner step surfaces respectively.

### TECHNICAL FIELD

The present invention relates to a filtration apparatus and a hollow fiber membrane module therefor.

### BACKGROUND ART

The separation methods for water treatment to purify the water by removing impurities therefrom include a heating or phase-change method, a filtration membrane method, and the like. According to the filtration membrane method, it is possible to obtain the water of quality as desired by controlling the size of the fine pores of the filtration membrane, which advantageously improves the reliability of process. Furthermore, since the filtration membrane method does not require a heating process, it can be advantageously used for water treatment using microorganisms that could be adversely affected by heat.

Among the filtration membrane methods is a method using a hollow fiber membrane module in which a bundle of hollow fiber membranes are disposed. Conventionally, the hollow fiber membrane module is widely used in the field of precision filtration such as preparation of sterile water, drinking water, ultrapure water or the like. Recently, however, the application field of the hollow fiber membrane module is extending to sewage/waste water disposal, separation of solids in sewage disposal tank, removal of suspended solids (SS) in industrial waste water, filtration of stream water, filtration of industrial water, filtration of pool water and the like.

Generally, a filtration method can be classified into a submerged-type and a pressurized-type depending on the operation manner thereof.

In a pressurized-type, a bundle of hollow fiber membranes are disposed inside a module case. As feed water is supplied into the module case with a pressure higher than a predetermined one, only pure fluid is allowed to permeate the hollow fiber membranes.

In a submerged-type, a bundle of hollow fiber membranes are submerged in feed water to be treated which is contained in a bath disposed under the ground. As a negative pressure is applied inside the hollow fiber membrane submerged in the feed water, only pure fluid is allowed to permeate the membrane while the contaminants are not.

The pressurized-type is more vulnerable to the contamination of the hollow fiber membranes than the submerged-type because the hollow fiber membranes of the pressurized-type exist in the module case with high packing density. Thus, the submerged-type is mainly used especially when the feed water with relatively high density of contaminants is treated.

The submerged-type, however, causes an inconvenience in that it is required to dispose a bath under the ground and properly arrange the hollow fiber membrane modules in the bath based on the shape and size of the bath.

Besides, the submerged-type i) is dangerous as well as inconvenient in that an operator needs to go down to the bath disposed under the ground for the maintenance of the filtration system, ii) causes an inconvenience in that it is required to periodically remove the sludge deposited in the bath during the filtration process, and iii) has a drawback in that there is a limit to the improvement of the integration degree of the hollow fiber membrane modules since they are mounted on a frame structure and then submerged in the feed water with the frame structure.

### DISCLOSURE

### Technical Problem

Therefore, the present invention is directed to a filtration apparatus capable of preventing these limitations and drawbacks of the related art, and a hollow fiber membrane module therefor.

An aspect of the present invention is to provide a submerged-type filtration apparatus which is readily installable, is maintainable safely and conveniently, has high degree of integration of the hollow fiber membrane modules, is suitable for standardization, has excellent drain efficiency, and has high merchantable quality.

Another aspect of the present invention is to provide a hollow fiber membrane module having headers to which both ends of a hollow fiber membrane are potted respectively, the hollow fiber membrane module performing water treatment with the headers not coupled to a frame, and the distance between the headers being variable when the hollow fiber membrane module performs the water treatment.

Besides the aspects of the present invention as mentioned above, additional advantages and features of the present invention will be set forth in the description which follows or will become apparent to those having ordinary skill in the art from the following description.

### Technical Solution

In accordance with the one aspect of the present invention, there is provided a filtration apparatus comprising: a tank into which feed water is to be introduced, the tank comprising first and second inner step surfaces arranged opposite to each other; and a hollow fiber membrane module to be submerged in the feed water introduced in the tank, the hollow fiber membrane module comprising first and second headers and a hollow fiber membrane therebetween, wherein first and second ends of the first header are supported by the first and second inner step surfaces respectively.

In accordance with another aspect of the present invention, there is provided a hollow fiber membrane module comprising: a first header having a filtrate collecting space therein; a hollow fiber membrane, one end of the hollow fiber membrane being potted into the first header via a first fixing layer so that the hollow fiber membrane is in fluid communication with the filtrate collecting space of the first header; a second header disposed below the first header during water treatment process, the other end of the hollow fiber membrane being potted into the second header via a second fixing layer; and a supporting body for supporting the first and second headers in such a way that distance between the first and second headers can be varied within a predetermined range.

The general description provided above is only for illustration of the present invention and should not be construed as limiting the scope thereof.

### Advantageous Effect

The filtration apparatus of the present invention, although being a kind of submerged-type filtration apparatus, is as good as a pressurized-type filtration apparatus in terms of installation convenience because the installation can be completed only by connecting a tank inside which a hollow fiber membrane module is disposed to external pipes in a way similar to that for the pressurized-type filtration apparatus.

Further, since the tank of the filtration apparatus of the present invention is positioned on the ground, the filtration apparatus can be maintained more safely and more conveniently, and the sludge caused in the tank during the water treatment process can be discharged naturally by means of gravity thereby improving the drain efficiency of the filtration apparatus.

The filtration apparatus of the present invention does not require a frame structure because the hollow fiber membrane module inside the tank is mounted directly on the tank. As such, the degree of integration of the hollow fiber membrane modules can be improved.

According to the filtration apparatus of the present invention, the filtrate collecting space of the tank is positioned below the water level of the feed water in the tank so that the energy consumption for filtration can be reduced.

Further, the filtration apparatus of the present invention is suitable for standardization and, since it is supposed to be installed on the ground, the merchantable quality thereof can be improved by making it aesthetically.

According to the hollow fiber membrane module of the present invention, the distance between the two headers where both ends of the hollow fiber membrane are potted respectively is variable. Hence, any damages of the membrane which might occur if the membrane is scrapped on the adjoining module or on the wall of the tank can be avoided by removing any slack of the hollow fiber membrane before inserting it into the tank.

Further, when the shrinkage of the hollow fiber membrane is caused during the water treatment process, the distance between the headers where both ends of the hollow fiber membrane are potted can be automatically reduced depending on the degree of the shrinkage of the hollow fiber membrane. Consequently, the damage of the hollow fiber membrane as well as the separation of the hollow fiber membrane from the headers, both of which might be caused due to the membrane shrinkage, can be avoided. In other words, the hollow fiber membrane module of the present invention can respond to the shrinkage of the hollow fiber membrane by itself.

Additionally, during the aeration process for preventing the fouling of the membrane, the distance between the headers where both ends of the hollow fiber membrane are potted is frequently changed by the rising bubbles such that the vibration of the hollow fiber membrane module is magnified. When the distance between the headers becomes shorter than the length of the hollow fiber membrane thereby causing the slack in the hollow fiber membrane, the rising bubbles collide with the slack portion strongly. The magnification of the vibration of the hollow fiber membrane module and occurrence of the slack in the hollow fiber membrane during the aeration process maximize the aeration efficiency, and thus minimize the contamination of the membrane.

Other features and advantages of the present invention may be newly found through practice of the present invention.

### DESCRIPTION OF DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a perspective view of the filtration apparatus according to an embodiment of the present invention;

FIG. 2 is a cross-sectional view of the tank of FIG. 1 along the A-A′ line;

FIG. 3 is a perspective view of the hollow fiber membrane module according to an embodiment of the present invention;

FIG. 4 is a cross-sectional view of the hollow fiber membrane module of FIG. 3 along the I-I′ line;

FIG. 5 is a partial perspective view illustrating the coupling structure of the moving header and supporting body according to an embodiment of the present invention;

FIG. 6 to FIG. 9 are partial perspective views illustrating the coupling structures of the moving header and supporting body according to other embodiments of the present invention, respectively;

FIG. 10 is a cross-sectional view of the filtration apparatus of FIG. 1 along the A-A′ line;

FIG. 11 is a cross-sectional view of the filtration apparatus of FIG. 1 along the B-B′ line; and

FIG. 12 illustrates the method for securing the hollow fiber membrane module on the inner step surfaces of the tank according to the other embodiment of the present invention.

### MODE FOR INVENTION

Hereinafter, the filtration apparatuses and hollow fiber membrane modules according to the embodiments of the present invention will be described in detail with reference to the annexed drawings.

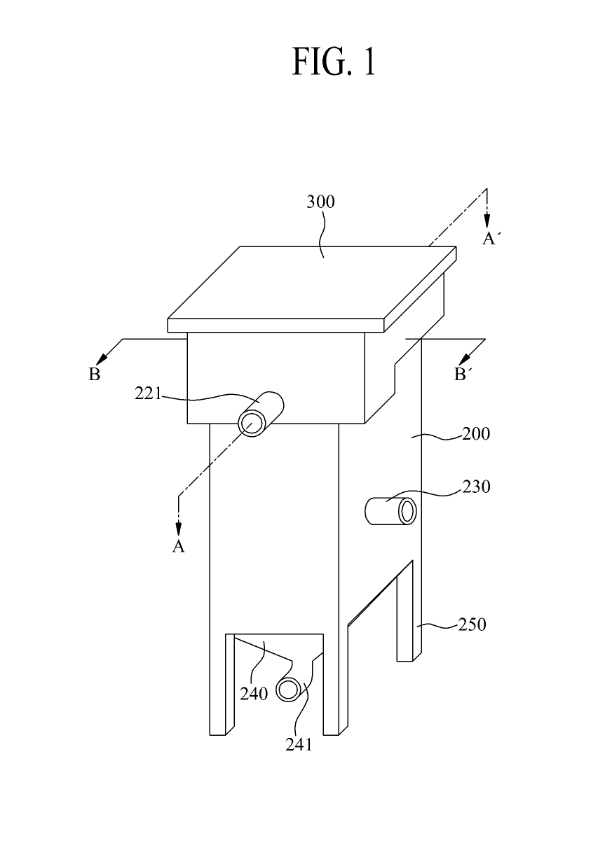

FIG. 1 is a perspective view of the filtration apparatus according to an embodiment of the present invention.

The filtration apparatus of the present invention comprises a tank 200 of shape as illustrated in FIG. 1. Feed water to be treated is introduced into the tank 200 through a feed water inlet port 230. The filtrate that has penetrated the hollow fiber membrane (not shown) mounted inside the tank 200 is discharged out of the tank 200 through the filtrate outlet port 221. That is, the negative pressure is supplied to the hollow fiber membrane through the filtrate outlet port 221.

The tank 200 of the present invention may include a sludge drain unit 240 at lower part thereof so as to smoothly discharge the sludge caused during the filtration process. The sludge drain unit 240 has a tapered shape getting narrower toward its bottom. The tank 200 of the present invention may further comprise legs 250 longer than the height of the sludge drain unit 240 so that the tank 200 can be supported stably on the ground.

Since the tank 200 of the filtration apparatus of the present invention is positioned on the ground, the filtration apparatus can be maintained more safely and more conveniently. Further, the sludge caused in the tank during the water treatment process can be naturally discharged out of the tank 200 through the sludge drain unit 240 and sludge drain port 241 by means of gravity thereby improving the drain efficiency of the filtration apparatus.

The filtration apparatus of the present invention, although being a kind of submerged-type filtration apparatus, is as good as a pressurized-type filtration apparatus in terms of installation convenience because the installation thereof can be completed only by connecting the feed water inlet port 230, filtrate outlet port 221, sludge drain port 241 and so on to the corresponding external pipes (not shown) respectively

The tank 200 has an opening at the upper part thereof for the installation of the hollow fiber membrane module (not shown) and the maintenance thereof. The hollow fiber membrane module can be introduced or withdrawn into or from the tank 200 through the opening.

Furthermore, for the aesthetic value and safety, the filtration apparatus of the present invention can further comprise a lid 300.

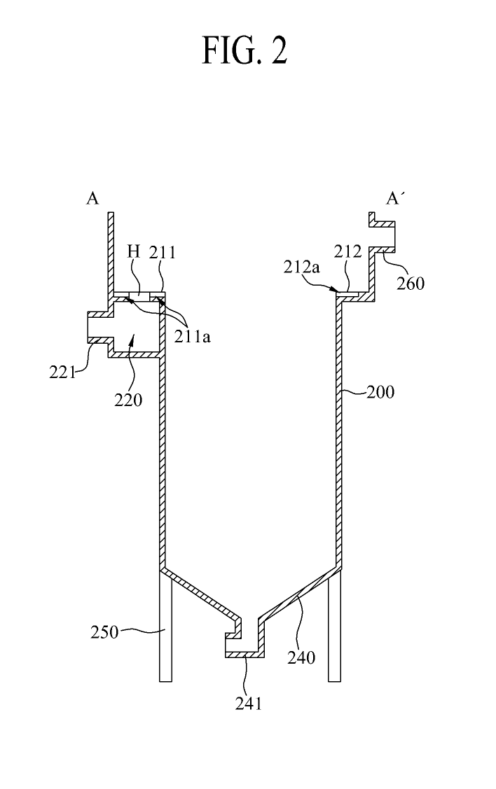

FIG. 2 is a cross-sectional view of the tank of FIG. 1 along the A-A′ line.

As illustrated in FIG. 2, the tank 200 of the present invention comprises the first step surface 211 and the second inner step surface 212 arranged opposite to the first step surface 211. Based on the first and second inner step surfaces 211 and 212, the inner space of the tank 200 may be divided into an upper space above them and a lower space below them. That is, the tank 200 of the present invention includes the upper and lower spaces. According to an illustrative embodiment of the present invention, the horizontal cross-sectional area of the upper space is larger than that of the lower space.

Below the first inner step surface 211 of the tank 200 is provided a filtrate collecting space 220 for the filtrate produced by the hollow fiber membrane. The filtrate introduced in the filtrate collecting space 220 is discharged through the filtrate outlet port 221.

The tank 200 of the present invention may further comprise an overflow drain port 260 for discharging the feed water out of the tank 200 when the amount of the feed water that has been introduced in the tank 200 through the feed water inlet port 230 becomes more than a predetermined level.

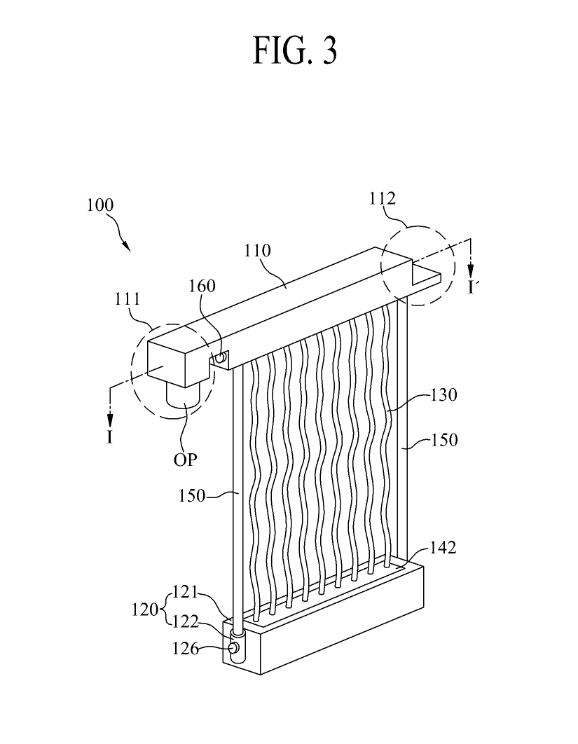

Hereinafter, referring to FIG. 3 to FIG. 9, the hollow fiber membrane modules of the present invention which are supposed to be installed inside the tank 200 will be described in detail.

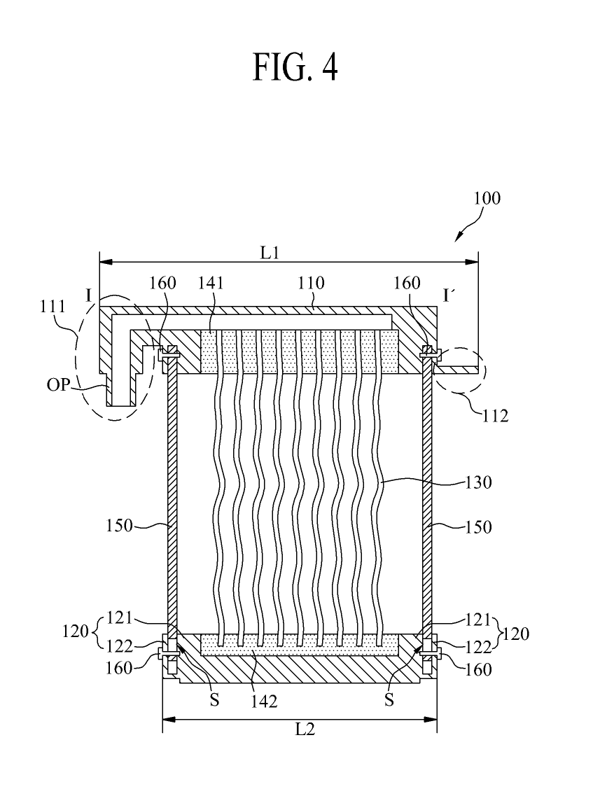

FIG. 3 is a perspective view of the hollow fiber membrane module 100 according to an embodiment of the present invention, and FIG. 4 is a cross-sectional view of the hollow fiber membrane module 100 of FIG. 3 along the I-I′ line.

The hollow fiber membrane module 100 according to an embodiment of the present invention comprises a first header 110, a second header 120, and a hollow fiber membrane 130 between the first and second headers 110 and 120. According to one embodiment of the present invention, the length L1 of the first header 110 is longer than the length L2 of the second header 120. During the water treatment process of the hollow fiber membrane module 100, the second header 120 is below the first header 110 and the hollow fiber membrane 130 is arranged in such a way that the longitudinal direction thereof is perpendicular to the water surface.

The polymer resin for manufacturing the hollow fiber membrane 130 of the present invention comprises at least one of polysulfone resin, polyethersulfone resin, sulfonated polysulfone resin, polyvinylidene fluoride (PVDF) resin, polyacrylonitrile (PAN) resin, polyimide resin, polyamideimide resin, and polyesterimide resin.

The hollow fiber membrane 130 according to one embodiment of the present invention may be a single-layer membrane or a composite membrane. If the hollow fiber membrane 130 is a composite membrane, it may comprise a tubular braid and a polymer thin film coated thereon. The tubular braid may be manufactured with polyester or nylon.

One end of the hollow fiber membrane 130 is potted into the first header 110 via the first fixing layer 141. The first header 110 comprises the first and second ends 111 and 112 and has a filtrate collecting space therein. The hollow fiber membrane 130 is in fluid communication with the filtrate collecting space of the first header 110. That is, the filtrate penetrating the hollow fiber membrane 130 and flowing into the lumen of the hollow fiber membrane 130 is introduced into the filtrate collecting space of the first header 110. The filtrate introduced in the filtrate collecting space is discharged through the outlet port OP on the first end 111 of the first header 110.

The other end of the hollow fiber membrane 130 is potted into the second header 120 via the second fixing layer 142. According to one embodiment of the present invention, since the filtrate penetrating the hollow fiber membrane 130 is supposed to flow only toward the first header 110, the second header 120 does not have a filtrate collecting space therein. However, the present invention is not limited to such structure, and the second header 120 can be designed to have a filtrate collecting space so that the filtrate penetrating the hollow fiber membrane 130 can flow toward the second header 120, too.

According to the present invention, when the hollow fiber membrane module 100 is installed inside the tank 200, only the first header 110 of the hollow fiber membrane module 100 is supported by the first and second inner step surfaces 211 and 212 of the tank 200 at the first and second ends 111 and 112 thereof, and the second header 120 is not in direct contact with the tank 200 and thus could move relatively freely (detailed explanation about this will follow). That is, when water treatment is performed by a plurality of hollow fiber membrane modules 100 installed inside the tank 200, the adjoining second headers 120 might be bumped against each other and, if such collision continues, the hollow fiber membrane modules 100 might be damaged.

Thus, to restrict the movement of the second headers 120 and prevent the adjoining second headers 120 from bumping against each other, the hollow fiber membrane module 100 of the present invention further comprises a supporting body 150 for connecting and supporting the first and second headers 110 and 120.

According to the present invention, the supporting body 150 supports the first and second headers 110 and 120 in such a way that the distance between the first and second headers 110 and 120 can be varied within a predetermined range. Two supporting bodies 150 may be coupled to both end portions of the first and second headers 110 and 120 with the fastening members 160, respectively.

According to one embodiment of the present invention, one end of the supporting body 150 is inserted into a groove formed on the first header 110 and then fixed thereto with the fastening member 160. That is, the first header 110 is a fixed header to which the supporting body 150 is coupled in such a way that their relative movement cannot be made. On the other hand, the second header 120 is a moving header to which the supporting body 150 is coupled in such a way that it can make relative movement with respect to the header. Thus, the second header 120 makes relative movement with respect to the supporting body 150 with the first header 110 fixed to the supporting body 150 such that the distance between the first and second headers 110 and 120 can be varied within a predetermined range.

According to such embodiment of the present invention, when the shrinkage of the hollow fiber membrane 130 is caused during the water treatment process, the distance between the headers 110 and 120 where both ends of the hollow fiber membrane 130 are potted can be automatically reduced, without any additional adjustment provided by a source outside the module 100, depending on the degree of the shrinkage of the hollow fiber membrane 130.

Although the embodiment of the present invention as shown in FIG. 3 and FIG. 4 illustrates a module in which the first header 110 is a fixed header and the second header 120 is a moving header, the present invention is not limited thereto. That is, a module may be prepared in which the first header 110 is a moving header and the second header 120 is a fixed header. Further, a module in which both of the first and second headers 110 and 120 are moving headers is also one of the alternatives.

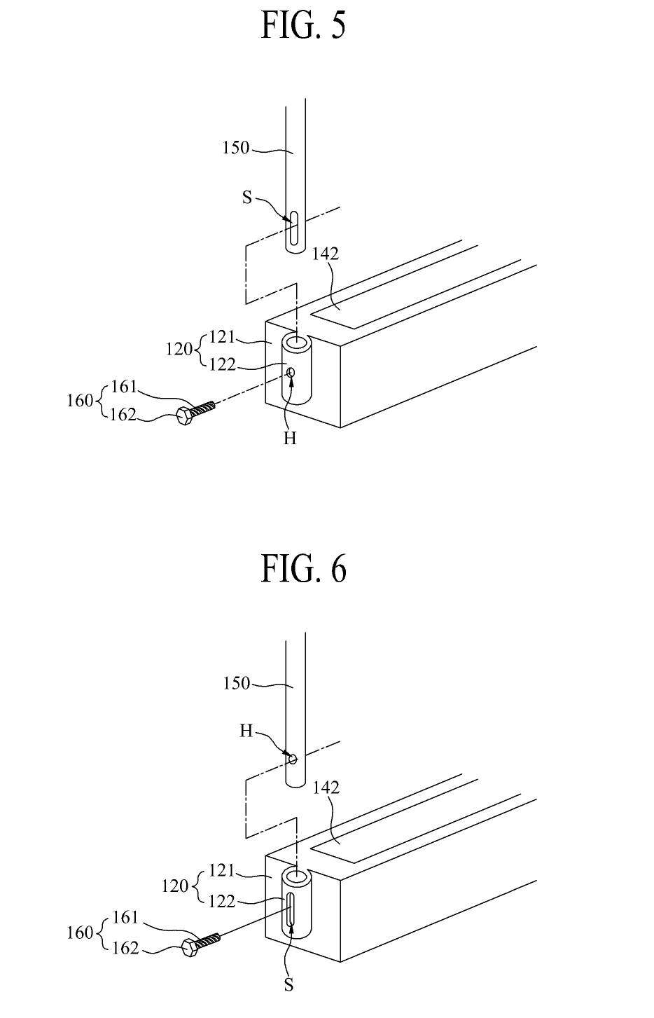

Hereinafter, referring to FIG. 5, the coupling structure of the moving header and supporting body according to one embodiment of the present invention will be explained in detail.

As illustrated in FIG. 5, the second header 120 which is a moving header in this embodiment comprises a header body 121 and a guide member 122 at the ends thereof. The supporting body 150 has a slit S at its end portion. The length of the slit S may be 0.5 to 3% of the length of the hollow fiber membrane 130. After the end portion of the supporting member 150 is inserted in the groove of the guide member 122, a fastening member 160 passes through the hole H formed on the guide member 122 and the slit S of the supporting body 150 sequentially. And then, it is inserted into the header body 121 so as to be secured thereto.

Optionally, it is also possible not to insert the fastening member 160 to the header body 121 after it passes through the hole H of the guide member 122 and the slit S of the supporting body 150 sequentially. In this embodiment, it needs to be guaranteed that the fastening member 160 and guide member 122 are firmly secured to each other.

The fastening member 160 may comprise a body 161 and a head 162. The body 161 of the fastening member 160 passes through the slit S of the supporting body 150 and is inserted into the header body 121 to be secured thereto.

Guided by the slit S of the supporting body 150, the fastening member 160 secured to the second header 120 which is a moving header can make relative movement with respect to the supporting body 150 within the range corresponding to the length of the slit S, i.e., 0.5 to 3% of the length of the hollow fiber membrane 130. In other words, the supporting body 150 can make relative movement with respect to the second header 120 and fastening member 160, in which the guide member 122 guides the relative movement of the supporting body 150.

Consequently, the second header 120 to which the fastening member 160 is secured can make relative movement with respect to the first header 110 to which the supporting body 150 is fixed.

Although FIG. 3 to FIG. 5 illustrate the second header 120, a moving header, which has a guide member 122, the guide member 122 is merely an optional element and the present invention is not limited thereto. That is, it is also possible that the second header 120 consists of the header body without the guide member and the fastening member 160 is secured to the header body 121 after passing through the slit S of the supporting body 150. In this embodiment, the fastening member 160 further comprises, in addition to the body 161 secured to the header body 121, a head 162 for preventing the second header 120, a moving header, from being separated from the supporting body 150.

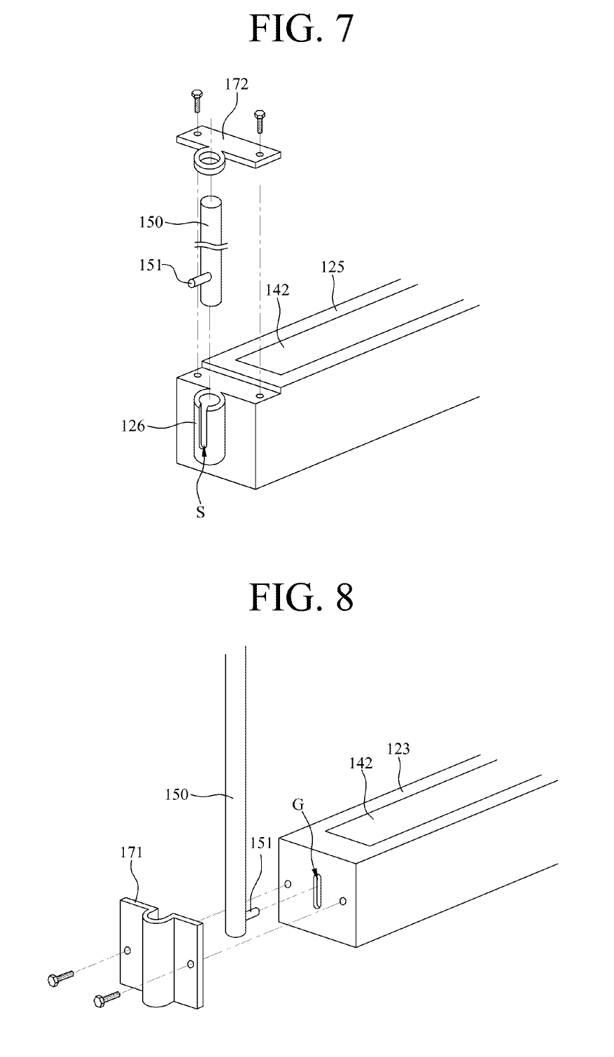

Hereinafter, referring to FIG. 6 to FIG. 9, the coupling structures of the moving header and supporting body according to other embodiments of the present invention will be explained in detail.

According to the embodiment illustrated in FIG. 6, the second header 120, a moving header, comprises a header body 121 and a guide member 122 at the ends thereof. The guide member 122 has a slit S. After the end portion of the supporting member 150 is inserted in the groove of the guide member 122, a fastening member 160 is inserted into the groove formed on the supporting body 150 via the slit S of the guide member 122.

Guided by the slit S of the guide member 122, the fastening member 160 secured to the supporting body 150 can make relative movement with respect to the guide member 122 within the range corresponding to the length of the slit S, in which the guide member 122 guides the relative movement of the supporting body 150.

The fastening member 160 may comprise a body 161 and a head 162. The body 161 of the fastening member 160 is inserted into the supporting body 150 via the slit S of the guide member 122. The head 162 of the fastening member 160 prevents the guide member 122 and supporting body 150 from being separated from each other.

Consequently, the second header 120 can make relative movement with respect to both the supporting body 150 to which the fastening member 160 is secured and the first header 110 to which the supporting body 150 is fixed.

According to the embodiment illustrated in FIG. 7, the moving header comprises a header body 125 and a guide member 126 at the ends thereof. The guide member 126 has an open slit S. The supporting body 150 comprises a protrusion 151 at its end portion.

When the supporting body 150 is inserted in the groove of the guide member 126, the protrusion 151 of the supporting body 150 is inserted in the slit S through the opened portion of the slit S of the guide member 126. Subsequently, a stopper 172 is coupled with the header body 125 and guide member 126 so as to prevent the protrusion 151 of the supporting body 150 from leaving the slit S of the guide member 126 through the opened portion, i.e., to prevent the guide member 126 and supporting body 150 from being separated from each other.

Owing to such structure as descried above, guided by the slit S of the guide member 126, the protrusion 151 of the supporting body 150 can make relative movement with respect to the guide member 126 and second header 120. That is, the moving header can make relative movement with respect to the first header 110 to which the supporting body 150 is fixed.

According to the embodiment illustrated in FIG. 8, the supporting body 150 comprises a protrusion 151 at its end portion. An elongated groove G into which the protrusion 151 of the supporting body 150 is formed on the side surface of the moving header 123. The elongated groove G extends parallel to the longitudinal direction of the supporting body 150.

The protrusion 151 of the supporting body 150 is inserted in the elongation groove G of the moving header 123, and then a stopper 171 is coupled with the moving header 123 at the side surface where the elongated groove G is formed so as to prevent the moving header 123 and supporting body 150 from being separated from each other.

Owing to such structure as descried above, guided by the elongated groove G of the moving header 123, the protrusion 151 of the supporting body 150 can make relative movement with respect to the moving header 123. That is, the moving header 123 can make relative movement with respect to the first header 110 to which the supporting body 150 is fixed.

According to the embodiment illustrated in FIG. 9, the moving header comprises a header body 121 and a protrusion 127 on a side surface of the header body 121. The supporting body 150 has a slit S into which the protrusion 127 of the moving header is inserted.

A stopper 173 is provide on the end of the protrusion 127 passing through the slit S of the supporting body 150 so as to prevent the moving header and supporting body 150 from being separated from each other. If the protrusion 127 of the moving header is too short to pass through the slit S of the supporting body 150 and any portion thereof does not protrude out of the slit S, the stopper as illustrated in FIG. 8 may be used to prevent the moving header and supporting body 150 from being separated from each other.

Owing to such structure as descried above, guided by the slit S of the supporting body 150, the protrusion 127 of the moving header can make relative movement with respect to the supporting body 150. That is, the moving header can make relative movement with respect to the first header 110 to which the supporting body 150 is fixed.

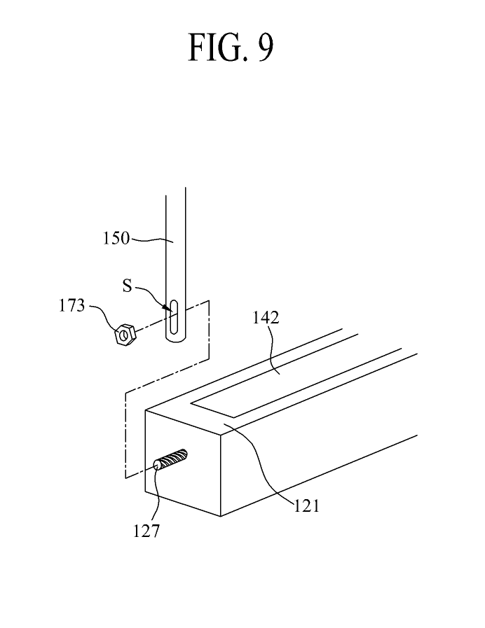

Hereinafter, referring to FIG. 10 to FIG. 12, the explanation regarding the combination of the elements of the filtration apparatus of the present invention will be made.

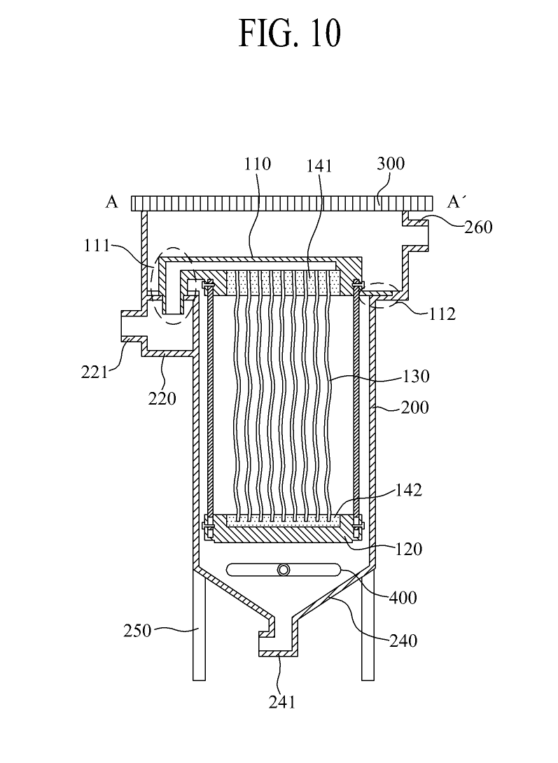

FIG. 10 and FIG. 11 are cross-sectional views of the filtration apparatus of FIG. 1 along the A-A′ line and B-B′ line, respectively.

As illustrated in FIG. 10, the first and second ends 111 and 112 of the first header 110 of the hollow fiber membrane module 100 are supported by the first and second inner step surfaces 211 and 212 respectively in the tank 200. That is, the hollow fiber membrane modules 100 are mounted directly on the tank 200. Consequently, The filtration apparatus of the present invention does not require a frame structure for the installation of the hollow fiber membrane modules 100, and thus the degree of integration of the hollow fiber membrane modules 100 can be improved.

As explained above, according to the hollow fiber membrane module 100 of the present invention, the distance between the first and second headers 110 and 120 where both ends of the hollow fiber membrane 130 are potted respectively can be varied. Therefore, any damages of the membrane 130 which might occur if the membrane 130 is scrapped on the adjoining module or on the wall of the tank can be avoided by removing the slack of the hollow fiber membrane 130 before inserting it into the tank 200. Further, when the shrinkage of the hollow fiber membrane 130 is caused during the water treatment process, the distance between the headers 110 and 120 where both ends of the hollow fiber membrane 130 are potted can be automatically reduced depending on the degree of the shrinkage of the hollow fiber membrane 130. Consequently, any damage of the hollow fiber membrane due to the membrane shrinkage can be avoided.

A hole H is formed on the first inner step surface 211 of the tank 200 and the outlet port OP of the first header 110 is inserted into the hole H of the first inner step surface 211 such that the first header 110 is in fluid communication with the filtrate collecting space 220. Accordingly, the filtrate penetrating the hollow fiber membrane 130 passes through the lumen of the hollow fiber membrane 130 and the filtrate collecting space of the first header 110 sequentially, and then flows into the filtrate collecting space 220 of the tank 200. The feed water not treated can be prevented from flowing into the filtrate collecting space 220 of the tank 200 by interposing an O-ring between the outer circumferential surface of the outlet port OP of the first header 110 and the inner circumferential surface of the hole H of the first inner step surface 211.

According to an embodiment of the present invention, the filtrate collecting space 220 of the tank 200 is positioned below the first header 110 of the hollow fiber membrane module 100, i.e., the filtrate collecting space 220 is positioned below the water level of the feed water in the tank 200, so that the energy consumption for filtration can be reduced.

According to an embodiment of the present invention, the length L2 of the second header 120 is sufficiently short that, when the installation of the hollow fiber membrane module 100 is performed, the second header 120 of the hollow fiber membrane module 100 can be inserted into the lower space of the tank 200 without being interrupted by the first and second inner step surfaces 211 and 212 of the tank 200. On the other hand, the length L1 of the first header 110 is sufficiently long that the first header 100 can be supported by the first and second inner step surfaces 211 and 212 at the ends thereof at the same time. That is, the length L1 of the first header 110 is longer than the length L2 of the second header 120.

There are provided the aeration pipes 400 under the hollow fiber membrane modules 100 installed in the tank 200 of the present invention. Bubbles emitted from the aeration pipes 400 can prevent the contamination of the hollow fiber membrane 130 during the filtration process.

According to one embodiment of the present invention, the first and second inner step surfaces 211 and 212 have grooves 211a and 212a of shapes and sizes corresponding to the shapes and sizes of the first and second ends 111 and 112 of the first header 110, respectively. The first and second ends 111 and 112 of the first header 110 is inserted in the grooves 211a and 212a respectively such that the horizontal movement of the first header 110 of the hollow fiber membrane module 100 can be prevented and thus the collision between the adjoining first headers 110 can be avoided.

Further, since the first and second headers 110 and 120 of the hollow fiber membrane module 100 of the present invention are supported by the supporting body 150 at the same time, the inhibition of horizontal movement of the first headers 110 can prevent the second headers 120 from colliding with each other. Therefore, according to the present invention, any damages of the hollow fiber membrane modules 100 which otherwise might be caused due to their collisions attributable to the bubbles emitted from the aeration pipes 400 can be avoided.

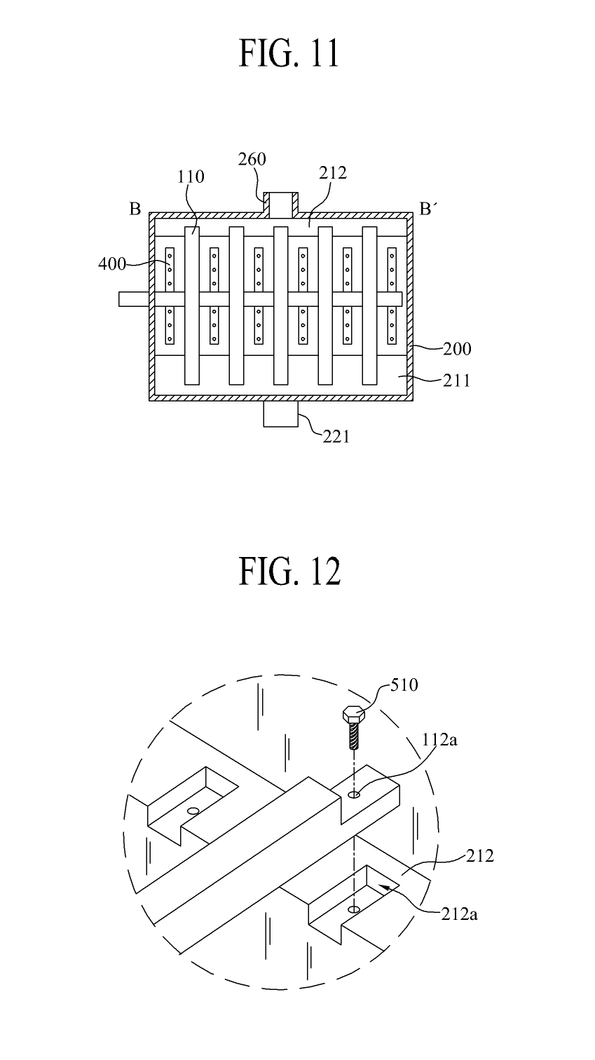

FIG. 12 illustrates a method according to the other embodiment of the present invention for securing the second end 112 of the first header 110 of the hollow fiber membrane module 100 on the second inner step surface 212 of the tank 200.

According to the embodiment of the present invention as illustrated in FIG. 12, to effectively preventing the hollow fiber membrane modules 100 inside the tank 200 from colliding with each other, the second end 112 of the first header 110 is inserted in the groove 212a formed on the second inner step surface 212 of the tank 200 and secured thereto with a fastening means 510. In such embodiment, the second end 112 of the first header 110 has a coupling hole 112a into which the fastening means can be inserted.

According to the present invention, during the aeration process for preventing the membrane contamination, the distance between the first and second headers 110 and 120 where both ends of the hollow fiber membrane 130 are potted is frequently changed by the rising bubbles emitted from the aeration pipes 400 such that the vibration of the hollow fiber membrane module 100 is magnified.

To explain more precisely, the second header 120 vibrates up and down due to the rising bubbles emitted from the aeration pipes 400 within the range corresponding to the length of the slit S, i.e., 0.5 to 3% of the length of the hollow fiber membrane 130.

Further, when the second header 120 moves upwardly, the distance between the first and second headers 110 and 120 becomes shorter than the length of the hollow fiber membrane 130 thereby instantaneously causing the slack in the hollow fiber membrane 130 and the rising bubbles emitted from the aeration pipes 400 collide with the slack portion strongly.

The magnification of the vibration of the second header 120 and occurrence of the slack in the hollow fiber membrane 130 during the aeration process maximize the aeration efficiency, and thus minimize the membrane contamination.

1. A filtration apparatus comprising:
a tank into which feed water is to be introduced, the tank comprising first and second inner step surfaces arranged opposite to each other; and
a hollow fiber membrane module to be submerged in the feed water introduced in the tank, the hollow fiber membrane module comprising first and second headers and a hollow fiber membrane therebetween,
wherein first and second ends of the first header are supported by the first and second inner step surfaces respectively.

2. The filtration apparatus of claim 1, wherein the first header is longer than the second header.

3. The filtration apparatus of claim 1, wherein the tank includes an upper space above the first and second inner step surfaces and a lower space below the first and second inner step surfaces, and horizontal cross-sectional area of the upper space is larger than horizontal cross-sectional area of the lower space.

4. The filtration apparatus of claim 1, wherein the tank includes a filtrate collecting space for filtrate produced by the hollow fiber membrane module.

5. The filtration apparatus of claim 4, wherein the filtrate collecting space of the tank is below the first header of the hollow fiber membrane module.

6. The filtration apparatus of claim 4, wherein the first inner step surface has a hole, and the first end of the first header is inserted into the hole of the first inner step surface so that the first header is in fluid communication with the filtrate collecting space of the tank.

7. The filtration apparatus of claim 6, wherein the second end of the first header is secured to the second inner step surface by means of a fastening means.

8. The filtration apparatus of claim 1, wherein the first and second inner step surfaces have grooves of shapes and sizes corresponding to shapes and sizes of the first and second ends of the first header, respectively.

9. The filtration apparatus of claim 1, wherein the tank includes a sludge drain unit at lower part thereof, the sludge drain unit having a tapered shape getting narrower toward bottom thereof.

10. The filtration apparatus of claim 1, wherein the tank further comprises an overflow drain port for discharging the feed water out of the tank when amount of the feed water introduced in the tank becomes more than a predetermined level.

11. A hollow fiber membrane module comprising:
a first header having a filtrate collecting space therein;
a hollow fiber membrane, one end of the hollow fiber membrane being potted into the first header via a first fixing layer so that the hollow fiber membrane is in fluid communication with the filtrate collecting space of the first header;
a second header disposed below the first header during water treatment process, the other end of the hollow fiber membrane being potted into the second header via a second fixing layer; and
a supporting body for supporting the first and second headers in such a way that distance between the first and second headers can be varied within a predetermined range.

12. The hollow fiber membrane module of claim 11, wherein at least one of the first and second headers is a moving header to which the supporting body is coupled in such way that the supporting body can make relative movement with respect to the moving header.

13. The hollow fiber membrane module of claim 12, wherein the supporting body has a slit,
the hollow fiber membrane module further comprises a fastening member passing through the slit and being secured to the moving header, and
guided by the slit of the supporting member, the fastening member can make relative movement with respect to the supporting member.

14. The hollow fiber membrane module of claim 13, wherein the fastening member comprises:
a body passing through the slit and being secured to the moving header; and
a head for preventing the moving header and supporting body from being separated from each other.

15. The hollow fiber membrane module of claim 12, wherein the moving header comprises a guide member for guiding the relative movement of the supporting body, and the supporting body is inserted in the guide member.

16. The hollow fiber membrane module of claim 15, wherein the guide member has a slit,
the hollow fiber membrane module further comprises a fastening member inserted in the supporting body via the slit of the guide member, and
guided by the slit of the guide member, the fastening member can make relative movement with respect to the guide member.

17. The hollow fiber membrane module of claim 16, wherein the fastening member comprises:
a body inserted in the supporting body via the slit of the guide member; and
a head for preventing the guide member and supporting body from being separated from each other.

18. The hollow fiber membrane module of claim 15, wherein the supporting body comprises a protrusion,
the guide member has a slit into which the protrusion of the supporting body is inserted, and
guided by the slit of the guide member, the protrusion of the supporting body can make relative movement with respect to the guide member.

19. The hollow fiber membrane module of claim 18, further comprises a stopper for preventing the guide member and supporting body from being separated from each other.

20. The hollow fiber membrane module of claim 12, wherein the supporting body comprises a protrusion,
an elongated groove into which the protrusion of the supporting body is inserted is formed on a side surface of the moving header,
the elongated groove extends parallel to a longitudinal direction of the supporting body, and
guided by the elongated groove, the protrusion of the supporting body can make relative movement with respect to the moving header.

21. The hollow fiber membrane module of claim 20, further comprises a stopper for preventing the moving header and supporting body from being separated from each other.

22. The hollow fiber membrane module of claim 12, wherein the moving header comprises a protrusion,
the supporting body has a slit into which the protrusion of the moving header is inserted, and
guided by the slit of the supporting body, the protrusion of the moving header can make relative movement with respect to the supporting body.

23. The hollow fiber membrane module of claim 22, further comprises a stopper for preventing the moving header and supporting body from being separated from each other, the stopper being provided on an end of the protrusion passing through the slit of the supporting body.

24. The hollow fiber membrane module of claim 11, wherein the first header is longer than the second header.
